(19) United States
(12) Patent Application Publication
(10) Pub. No.: US 2008/0192746 A1
(43) Pub. Date: Aug. 14, 2008

(54) Systems and methods for communicating secure media

(76) Inventors: Donald Vincent DiPietro, Los Angeles, CA (US); Alex Lightman, Santa Monica, CA (US)

Correspondence Address: JONES DAY, 222 EAST 41ST ST, NEW YORK, NY, 10017, US

(21) Appl. No.: 11/704,539

(22) Filed: Feb. 9, 2007

(51) Int. Cl. H04L 12/56

(52) U.S. Cl. 370/392; 370/474

(57) ABSTRACT

An apparatus for communicating a video having a central processing unit and a communications circuit in communication with a source and destination computer is provided A memory coupled to the central processing unit stores a lookup table of accounts and a router module that controls the communications circuit by (i) reading an address of each of a plurality of packets received by the communications circuit, where the packets store an encoded video containing at least one embedded IP address and where the packets each contain a destination address, and (ii) by routing the packets to a destination computer based on the destination address. The memory further has a media analyzer module with instructions for identifying a value of the at least one embedded IP address in the packets. The memory further has an accounting module for charging an account in the lookup table for the encoded video.

### CROSS REFERENCE TO RELATED APPLICATION

This application is related to U.S. patent application Ser. No. to be determined, filed Feb. 9, 2007, bearing attorney docket number 11723-005-999, entitled Systems and Methods for Securing Media, which is hereby incorporated by reference herein in its entirety.

### FIELD OF THE INVENTION

The present invention relates to systems and methods for securing media such as motion pictures that contain picture frames. The present invention can be used as a substitute for, or in conjunction with, conventional digital rights management techniques.

### BACKGROUND OF THE INVENTION

The advent of personal computers, the ease by which media files can be copied from a DVD or CD or from cable television without authorization, combined with the Internet and popular file sharing tools, have made unauthorized sharing of media, often referred to as digital piracy, possible and profitable. To counteract such unauthorized copying, the broad field of digital rights management (DRM) has developed. DRM includes any of several technologies used by publishers and copyright owners to control access to and usage of digital data. In recent years, a number of television producers have begun demanding implementation of DRM measures to control access to the content of their shows on TiVo systems and its equivalents.

An example of a DRM system is the Content Scrambling System (CSS) employed by the DVD Forum on movie DVDs. The scheme uses a simple encryption algorithm, and requires device manufacturers to sign a license agreement restricting the inclusion of certain features in their players, such as a digital output that could be used to extract a high-quality digital copy of the movie. Under this scheme, the only consumer hardware capable of decoding DVD movies is controlled by the DVD Forum, thereby restricting the unauthorized use or copy of DVD media. CSS worked fine until the release of DeCSS by Jon Lech Johansen in 1999. DeCSS and related programs are capable of cracking the CSS code and therefore allowing users to make unauthorized copies of the encrypted media. A drawback of CSS, besides the fact that code is publicly available for cracking the code, is that it restricts the owners' use of purchased content, such as the creation of compilations or full quality reproductions, where such actions would ordinarily be permissible in many countries as fair use or some equivalent. CSS also prevents the user from playing encrypted DVDs on any computer platform, although this restriction can be easily circumvented with anti-encryption software. CSS is an example of certificate-based encryption.

In 2003, DNAML (Sydney, Australia) released the combination of an internal DRM System and Payment Gateway referred to as DNL DRM or Shareware eBooks. Publishers such as Thomson Education, Harper Collins and Wiley have now adopted this DRM system. DNL DRM allows for an instant CPU lock down post purchase without having to perform multiple tasks prior to activation.

Another DRM system is DIVX. Proposed as a content-rental only system, DIVX requires an active telephone line and modem, and thus inhibits the use of media offline or portably. To relocate a work for which unlimited play has been purchased, called DIVX Silver, it is necessary to carry the DVD player that first played the disk with it, or manually request that another player be authorized to play that disc. Consumers are denied certain fair use rights in countries with such doctrines, such as the ability to create compilations of purchased material and to re-sell their copy.

One drawback with some DRM systems is that they require product activation. Product activation restricts a product's functionality until it is registered with a publisher by means of a special identification code, often recording information about the specific computer the software is installed on to prevent its use across multiple machines. Activation schemes may place some users at risk by incorrectly identifying their purchased software as unauthorized. An example of this vulnerability occurred in 2003, when Intuit's use of a defective product activation scheme angered thousands of customers who were denied legitimate use of the product, resulting in a formal apology by Intuit and their cancellation of the system.

Some DRM systems use digital watermarking. Digital watermarking allows hidden data, such as a unique disc ID, to be placed on the media. The system allows such information as the name and address of the purchaser (acquired, for instance, taken at the point of sale), and entered into a database along with a unique ID for each copy (e.g, disk). In the most common implementation, this scheme does not prevent copying, but ensures that any copies made of the media will be traceable to a particular copy and perhaps to a particular user. However, the scheme relies largely on authenticating the purchaser's identity (e.g, at point of sale), and can be easily circumvented by a customer who provides false information. Any user who can generate such watermarks will also be able to circumvent the system, so there is also a reliance on restrictions in the use of either hardware or software.

A drawback common to conventional DRM techniques, such as those outlined above, is that once the key to the DRM (e.g., in the case of CSS) is determined, the media protected by the conventional DRM can be copied without authorization.

Another form of DRM are those that require public key/private key combinations. A number of public key/private key DRM systems have been proposed. For example, U.S. Pat. No. 7,162,745 to England et al., U.S. Pat. No. 6,948,073 to England et al, and U.S. Pat. No. 6,775,655 to Pelnado et al. disclose client-based rendering applications that determine that digital content is in an encrypted rights-protected form and, in response, invoke a DRM system that includes a license store containing one or more licenses. Each such license corresponds to a piece of digital content that includes a decryption key for decrypting the corresponding digital content. The DRM system locates each license in the license store corresponding to the digital content to be rendered, selects one of the located licenses, obtains the decryption keys from the selected licenses, decrypts the digital content with the keys, and returns the decrypted digital content to the rendering application. The DRM system acquires licenses from a license server. The license server only issues a license to a DRM system that is “trusted” (i.e., that can authenticate itself). To implement “trust”, the client-based DRM system is equipped with a “black box” that performs decryption and encryption functions for such DRM systems. The black box includes a public/private key pair, a version number and a unique signature, all as provided by an approved certifying authority. The public key is made available to the license server for purposes of encrypting portions of the issued license, thereby binding such licenses to the black box. The private key is available to the black box in the client-based DRM only, and not to the user or anyone else, for purposes of decrypting information encrypted with the corresponding public key. The DRM system is initially provided with a black box with a public/private key pair, and the user is prompted to download from a black box server an updated secure black box when the user first requests a license. The black box server provides the updated black box, along with a unique public/private key pair. The updated black box is written in unique executable code that will run only on the user's computing device, and is re-updated on a regular basis.

The drawback with public key/private key systems is that they are inconvenient to use. The user must obtain an updated secure black box from a black box server and a license for each requested digital media from a license server. To add to this inconvenience, once the user has acquired the rights to view the digital date on one system, the user must repeat the entire process of obtaining a secure black box and suitable licenses for each device the user wishes to view the digital media on, unless the license grants permission to make unencrypted copies of the digital media. And, if the license grants permission to make unencrypted copies of the digital media, the security provided by the DRM is effectively circumvented. Furthermore, if the client device ever becomes corrupt, for example through hard disk failure or viral infection, the DRM and associated licenses must be painstakingly rebuilt.

Given the above background, what is needed in the art are improved systems and methods for securing media.

### SUMMARY OF INVENTION

The present disclosure addresses the drawbacks found in the prior art. In the present disclosure, individual frames are watermarked or otherwise encoded with unique IP addresses. In preferred embodiments, each such IP address is an IPv6 address. When media encoded with the IP addresses is communicated to a client, the IP addresses in the media are read, and based on the identity of the IP addresses, either a third party or the recipient is charged for receiving the media. In some situations a different IP address is assigned to each frame in the media. In some situations, the encoded media consists of a single shot and the same IP address is assigned to each frame in the single shot. In some embodiments, the media comprises a plurality of shots and, for each respective shot in the plurality of shots, there is a different IP address unique to the respective shot that is assigned to frames in the respective shot.

Another aspect of the present disclosure provides an apparatus such as a movie camera that is branded with a unique IP address. Each frame recorded or generated by the apparatus is permanently watermarked with the unique IP address associated with the apparatus. In some embodiments, a collection of apparatuses, such as all of the equipment at a store or movie production house, is associated with the same IP address in such a manner that each frame produced by the collection of apparatuses is permanently watermarked with the IP address associated with the collection of apparatuses. In this way, all the content generated by the collection of apparatuses can be uniquely traced back to the collection of apparatuses.

One aspect of the disclosure provides an apparatus for encoding videos. The apparatus comprises a central processing unit and a memory coupled to the central processing unit. An example of such an apparatus is a movie camera in which the central processing unit is the microprocessor of the movie camera. In some embodiments, the apparatus is a scanner, digital camera or other electronic device. The memory comprises an Internet protocol (IP) address pool having a plurality of IP addresses (e.g., IPv6 addresses). The memory further comprises a video encoding module. The video encoding module comprises instructions for obtaining a video source comprising a plurality of sequential frames. Here, the term sequential means sequential in time, for example, frames that sequentially, over time, depict a common scene as in a movie. The video encoding module assigns select frames in the plurality of sequential frames with at least one IP address from the IP address pool, thereby forming an encoded video containing at least one embedded IP address. The video encoding module removes the at least one IP address assigned to the select frames from the IP address pool, thereby ensuring that IP addresses assigned to frames are unique. The encoded video is then stored, for example in electronic memory, tape, disc, or by other means, for later use and retrieval.

In some embodiments in accordance with the first aspect of the disclosure, the memory further comprises a server module. The server module monitors a communication port for requests for the encoded video and transmits a copy of the encoded video through the communication port when a request for the encoded video is received. In some embodiments, the communication port is a port such as a USB or FireWire port. For instance, the device may be connected to a client computer by a USB or FireWire cable. Such a client computer may have a graphical user interface driven software module for controlling the device. One of the functions of this client software may be to submit requests to the apparatus (e.g., movie camera) for the encoded video that has been stored in memory in the apparatus. When such requests are received, the server module may transmit the encoded video to the client. In a more complex apparatus within the scope of the present invention, the server module may monitor a communication port that is connected to the Internet or other form of network. When a request for the encoded video is received, the server module may transmit the request through the communication port over the Internet or other form of network.

In some embodiments, the video encoding module comprises instructions for repeating the obtaining, assigning, removing and storing for a plurality of different video sources, thereby storing a plurality of encoded videos. In such embodiments, the server module may comprise instructions for monitoring a communication port for requests for an encoded video in the plurality of encoded videos and transmitting a copy of the encoded video through the communication port when a request for the encoded video is received. In such embodiments, the request may specify which encoded video, from among the plurality of encoded videos, is desired. Further, in such embodiments, the requests may be received from a hard-wire cable, such as in the USB example described above, or from a network connection such as an Internet connection.

In some embodiments in accordance with the first aspect, the memory of the apparatus optionally further comprises a packet module. The packet module packetizes a copy of the encoded video into a plurality of packets prior to the transmission of the encoded video by the server module. The plurality of packets retain the at least one embedded IP address in the encoded video. Furthermore, in such embodiments, the instructions for transmitting of the server module transmit the encoded video as the plurality of packets.

The first aspect of the disclosure encompasses a broad array of encoding categories. In one encoding category, the instructions for assigning assigns a different IP address from the IP address pool to each frame in the plurality of sequential frames. In another encoding category, the video source is a single shot and the instructions for assigning assigns the same IP address from the IP address pool to each frame in the plurality of sequential frames. In still another encoding category, the video source comprises a plurality of shots and the instructions for assigning assign, for each respective shot in the plurality of shots, a different IP address from the IP address pool to select frames in the respective shot. Thus, consider the case in which the video source contains a first shot and a second shot. In this encoding category, frames in the first shot will be assigned a first IP address whereas frames in the second shot will be assigned a second IP address. As the term is used here, a “shot” refers to a contiguous set of frames bounded by physical start recording action and a physical stop recording action.

In yet another encoding category, the video source comprises a plurality of shots and the instructions for assigning assigns, for each respective shot in the plurality of shots, the same IP address from the IP address pool to select frames in the respective shot. In still another encoding strategy, the IP address pool consists of a single IP address and the instructions for assigning assign select frames in the plurality of sequential frames the single IP address from the IP address pool. Under this encoding strategy, each encoded video produced by the apparatus has an IP addresses that can uniquely be traced back to the apparatus. In some embodiments, several apparatus share this unique single IP address. For example, each piece of equipment capable of generating an image at an office services center (e.g., a Kinkos) watermarks or otherwise encodes the common IP address in video or still images generated by the equipment.

In some embodiments in accordance with the first aspect of the disclosure, the instructions for assigning further include instructions for encoding the plurality of sequential frames such that the encoded video is in a video compression file format that includes one or more key frames. In some such embodiments, the instructions for assigning assigns each of the one or more key frames in the encoded video a different IP address from the IP address pool. In other of such embodiments, the instructions for assigning assigns each of the one or more key frames in the encoded video the same IP address from the IP address pool.

In some embodiments in accordance with the first aspect of the disclosure, the instructions for assigning further include instructions for encoding the plurality of sequential frames such that the encoded video is in an MP3 file format that includes one or more I frames, one or more P frames, and one or more B frames. In some such embodiments, the instructions for assigning assigns each of the one or more I frames a different IP address from the IP address pool. In some such embodiments, the instructions for assigning also assign each of the one or more B frames and each of the one or more P frames a unique IP addresses from the IP address pool.

In embodiments where unique IP addresses are assigned to frames, there is the possibility that the IP address pool may become depleted (e.g., contain too few unassigned IP addresses or, in fact, no unassigned IP addresses) over time. In some embodiments, this situation is remedied by encoded instructions for obtaining additional IP addresses from a remote source when the plurality of IP address in the IP address pool is depleted.

A second aspect of the disclosure provides a method for encoding videos in which a video source comprising a plurality of sequential frames is obtained. Select frames in the plurality of sequential frames are assigned with at least one IP address (e.g., an IPv6 address) from an IP address pool, thereby forming an encoded video containing at least one embedded IP address. The at least one IP address that is in the encoded video is removed from the IP address pool and the encoded video is stored in a machine readable medium. In some embodiments, the method further comprises monitoring a communication port for requests for the encoded video and transmitting a copy of the encoded video through the communication port when a request for the encoded video is received.

In some embodiments in accordance with this second aspect of the disclosure, the method further comprises repeating the obtaining, assigning, removing and storing for a plurality of different video sources, thereby storing a plurality of encoded videos in a machine readable medium (e.g., electronic memory, compact disk, digital tape, etc.). In such embodiments, the method may further comprise monitoring a communication port for requests for a first encoded video in the plurality of encoded videos and transmitting a copy of the first encoded video through the communication port when a request for the encoded video is received.

In some embodiments in accordance with the second aspect of the disclosure, the method further comprises putting the copy of the encoded video into a plurality of packets prior to the transmitting step. In such embodiments, the plurality of packets retain the at least one embedded IP address in the encoded video and the transmitting step transmits the encoded video as the plurality of packets.

In some embodiments in accordance with the second aspect, the assigning step assigns a different IP address from the IP address pool to each frame in the plurality of sequential frames. In some embodiments, the video source is a single shot and the assigning step assigns the same IP address from the IP address pool to each frame in the plurality of sequential frames. In some embodiments, the video source comprises a plurality of shots and the assigning step assigns, for each respective shot in the plurality of shots, a different IP address from the IP address pool to select frames in the respective shot. In some embodiments, the video source comprises a plurality of shots and the assigning step assigns, for each respective shot in the plurality of shots, the same IP address from the IP address pool to select frames in the respective shot. In some embodiments, the IP address pool consists of a single IP address and the assigning step assigns select frames in the plurality of sequential frames the single IP address from the IP address pool. In some embodiments, the single IP address is shared by a plurality of apparatuses that assign the single IP address to video sources comprising a plurality of sequential frames.

In some embodiments in accordance with the second aspect, the assigning step further includes encoding the plurality of sequential frames such that the encoded video is in a video compression file format that includes one or more key frames. In some such embodiments, the assigning step assigns each of the one or more key frames in the encoded video a different IP address from the IP address pool. In other of such embodiments, the instructions for assigning assigns each of the one or more key frames in the encoded video the same IP address from the IP address pool.

In some embodiments in accordance with the second aspect, the assigning step further includes encoding the plurality of sequential frames such that the encoded video is in an MP3 file format that includes one or more I frames, one or more P frames, and one or more B frames. In such embodiments, the assigning step assigns each of the one or more I frames a different IP address from the IP address pool. In some embodiments, the assigning step further assigns each of the one or more B frames and each of the one or more P frames a different IP address from the IP address pool. In some embodiments in accordance with the second aspect, additional IP addresses are obtained from a remote source when the IP address pool is depleted.

A third aspect of the present disclosure is an apparatus for encoding videos. The apparatus comprises a central processing unit (e.g., an embedded microprocessor) and a memory coupled to the central processing unit. The memory comprises an Internet protocol (IP) address pool comprising a plurality of IP addresses (e.g., IPv6 addresses). The memory further comprises means for obtaining a video source having a plurality of sequential frames as well as means for assigning select frames in the plurality of sequential frames with at least one IP address from the IP address pool, thereby forming an encoded video containing at least one embedded IP address. The memory further comprises means for removing the at least one IP address from the IP address pool that is in the encoded video and means for storing the encoded video.

In some embodiments in accordance with the third aspect of the disclosure, the memory further comprises means for monitoring a communication port for requests for the encoded video and means for transmitting a copy of the encoded video through the communication port when a request for the encoded video is received by the apparatus. In some embodiments, the memory further comprises means for packetizing the copy of the encoded video into a plurality of packets prior to the transmission of the encoded video by the means for transmitting. The plurality of packets retain the at least one embedded IP address in the encoded video. Further, the means for transmitting transmit the encoded video as the plurality of packets.

A fourth aspect of the present disclosure is a video encoder module stored on a computer readable storage media. The video encoder module in accordance with this fourth aspect comprises a first plurality of binary values encoding an Internet protocol (IP) address pool having a plurality of IP addresses. The video encoder module comprises a second plurality of binary values for obtaining a video source having a plurality of sequential frames. The video encoder module comprises a third plurality of binary values for assigning select frames in the plurality of sequential frames with at least one IP address from the IP address pool, thereby forming an encoded video containing at least one embedded IP address (e.g., an IPv6 address). The video encoder module comprises a fourth plurality of binary values for removing the at least one IP address from the IP address pool that is in the encoded video. The video encoder module comprises a fifth plurality of binary values encoding instructions for storing the encoded video in a memory. In some embodiments, the computer readable storage media is a magnetic tape, an optical disc, a compact disc (CD), a digital video disk (DVD), a high definition digital video disk, ferroelectric memory, electrically erasable programmable read only memory (EEPROM), flash memory, EPROM, read only memory(ROM), static random access memory (SRAM), dynamic random access memory (DRAM), ferromagnetic memory, a charge coupled device, a smart card, a USB drive, or is within an integrated circuit.

In some embodiments, the video encoder module in accordance with the fourth aspect of the disclosure comprises a fifth plurality of binary values for monitoring a communication port for requests for the encoded video as well as a sixth plurality of binary values for transmitting a copy of the encoded video through the communication port when a request for the encoded video is received. In some embodiments, the video encoder module further comprises a seventh plurality of binary values for putting the copy of the encoded video into a plurality of packets prior to the transmission of the encoded video. The plurality of packets retain the at least one embedded IP address in the encoded video. In such embodiments, the sixth plurality of binary values transmit the encoded video as the plurality of packets.

In some embodiments in accordance with the fourth aspect of the disclosure, the video encoder module comprises a plurality of binary values encoding instructions for retrieving additional IP address for the IP address pool when the plurality of IP addresses is depleted. In some embodiments, each address in the plurality of IP addresses in the IP address pool is an IPv6 address.

A fifth aspect of the disclosure provides an apparatus for communicating a video. The apparatus comprises (i) a central processing unit, (ii) a communications circuit in electronic communication with a source computer and in electronic communication with at least one destination computer, and (iii) a memory coupled to the central processing unit. The memory comprises instructions for accessing a lookup table, the lookup table containing a plurality of accounts. The lookup table may be stored in the apparatus and/or be accessible to the apparatus from a remote location. The memory further comprises a router module comprising instructions for controlling the communications circuit. The instructions for controlling the communications circuit include instructions for reading an address of each of a plurality of packets received by the communications circuit. The plurality of packets collectively store an encoded video containing at least one embedded IP address. Furthermore, the plurality of packets each contain a destination address. The instructions for controlling the communications circuit further comprise instructions for routing the plurality of packets to a destination computer in the at least one destination computer based on the destination address. The memory in accordance with the fifth aspect of the disclosure further comprises a media analyzer module comprising instructions for identifying a value of the at least one embedded IP address in the plurality of packets and an accounting module for charging an account in the plurality of accounts for the encoded video.

In some embodiments in accordance with the fifth aspect of the disclosure, the encoded video comprises a plurality of frames and each frame in the plurality of frames is embedded with a different IP address (e.g., a different IPv6 address). In some embodiments, the encoded video comprises a single shot and each frame in the single shot is embedded with the same IP address. In some embodiments, the encoded video comprises a plurality of shots and the frames of each respective shot in the plurality of shots are assigned an IP address that is unique to the respective shot. In some embodiments, the encoded video is in a video compression file format that includes one or more key frames, and each of the one or more key frames in the encoded video is embedded with a different IP address. In some embodiments, the encoded video is in a video compression file format that includes one or more key frames, and each of the one or more key frames in the encoded video is embedded with the same IP address.

In some embodiments in accordance with the fifth aspect of the disclosure, the encoded video is in an MP3 file format that includes one or more I frames, one or more P frames, and one or more B frames, and each of the one or more I frames is embedded with a different IP address. In some embodiments, each of the one or more B frames and each of the one or more P frames is embedded with a different IP address.

In some embodiments in accordance with the fifth aspect of the disclosure, the communications circuit comprises a switch fabric with a plurality of input ports and a plurality of output ports. In some embodiments in accordance with the fifth aspect of the disclosure, the account that is charged is the account of an advertiser, the encoded video is an advertisement, and the account in the plurality of accounts is identified by a value of at least one embedded IP address in the encoded video. In some embodiments in accordance with the fifth aspect, the account is the account of a user of the destination computer and the accounting module further comprises instructions for crediting an account of an owner of the encoded video, where the account of the owner of the encoded video is in the plurality of accounts and is identified by a value of at least one embedded IP address in the encoded video.

A sixth aspect of the disclosure provides a method for communicating a video. An address of each of a plurality of received packets is read, where the plurality of received packets collectively stores an encoded video containing at least one embedded IP address and where the plurality of packets each contains a destination address. The plurality of packets are routed to a destination corresponding to (determined by) the destination address in the plurality of packets. A value of the at least one embedded IP address in the plurality of packets is identified and an account in a plurality of accounts is charged for the encoded video. In some embodiments, the encoded video comprises a plurality of frames and each frame in the plurality of frames is embedded with a different IP address. In some embodiments, the encoded video comprises a single shot and each frame in the single shot is embedded with the same IP address. In some embodiments, the encoded video comprises a plurality of shots and the frames of each respective shot in the plurality of shots are assigned an IP address that is unique to the respective shot. In some embodiments, the encoded video is in a video compression file format that includes one or more key frames, and each of the one or more key frames in the encoded video is embedded with a different IP address. In some embodiments, the encoded video is in a video compression file format that includes one or more key frames, and each of the one or more key frames in the encoded video is embedded with the same IP address. In some embodiments, the encoded video is in an MP3 file format that includes one or more I frames, one or more P frames, and one or more B frames, and each of the one or more I frames is embedded with a different IP address. In some such embodiments, each of the one or more B frames and each of the one or more P frames is embedded with a different IP address. In some embodiments in accordance with the sixth aspect of the disclosure, at least one embedded IP address is an IPv6 address.

In some embodiments in accordance with the sixth aspect, the account charged is the account of an advertiser, the encoded video is an advertisement, and the account in the plurality of accounts is identified by a value of at least one embedded IP address in the encoded video. In some embodiments in accordance with the sixth aspect, the account is the account of a user associated with the destination address, and the method further comprises the step of crediting an account of an owner of the encoded video, where the account of the owner of the encoded video has an account in the plurality of accounts and is identified by a value of at least one embedded IP address in the encoded video.

A seventh aspect of the disclosure provides an apparatus for communicating a video. The apparatus comprises a central processing unit and a memory coupled to the central processing unit. The memory comprises instructions for receiving a request for an encoded video from a destination, where the encoded video contains at least one embedded IP (e.g., IPv6) address. The memory further comprises instructions for communicating the encoded video to the destination address and instructions for charging an account in a plurality of accounts for the encoded video. In some embodiments in accordance with the seventh aspect, the account charged is the account of an advertiser, the encoded video is an advertisement, and the account in the plurality of accounts is identified by a value of at least one embedded IP address in the encoded video. In some embodiments in accordance with the seventh aspect, the account is the account of a user associated with the destination address, and the method further comprises crediting an account of an owner of the encoded video, where the account of the owner of the encoded video has an account in the plurality of accounts and is identified by a value of at least one embedded IP address in the encoded video.

### BRIEF DESCRIPTION OF THE DRAWINGS

FIG. 1A illustrates a device for encoding a video with IP addresses, thereby forming an encoded video.

FIG. 1B illustrates a device for analyzing packets that collectively store an encoded video containing at least one IP address, and for charging and/or crediting accounts when such packets are routed to a destination.

FIG. 1C illustrates a client-side device for receiving packets that collectively store an encoded video and for viewing the encoded video.

FIG. 2 illustrates process steps for acquiring frames from a video source, encoding frames in the video source with one or more IP addresses, and transmitting the encoded video to a client device, whereby an account is charged and/or credited when the encoded video is transmitted to a destination.

FIG. 3 illustrates various encoding categories for encoding frames in a video source.

FIG. 4A provides a flowchart illustrating the assignment of IP addresses to I frames during an encoding operation such as MP3 encoding.

FIG. 4B provides a flowchart illustrating the assignment of IP addresses to I frames, P frames and B frames during an encoding operation such as MP3 encoding.

Like reference numerals refer to corresponding parts throughout the several views of the drawings.

### DETAILED DESCRIPTION

The present disclosure provides systems and methods for securing data in which individual frames are watermarked or otherwise permanently encoded with unique IP addresses. In some embodiments, each such IP address is an IPv6 address. IPv6 follows Internet Protocol version 4 (IPv4) as the second version of the Internet Protocol to be formally adopted for general use. One improvement brought by the IPv6 standard is the increase in the number of IP addresses available. For example, while IPv4 supports 4.3×10⁹ (4.3 billion) IP addresses, the IPv6 standard supports 3.4×10³⁸ IP addresses. In an IPv6 system, each of the roughly 6.5 billion people alive today can have 5×10²⁸ (50 octillions) IP addresses. Alternatively, each gram of matter in the Earth can be assigned nearly 57 billion IP addresses. This is because an IPv6 address is 128 bits long whereas an IPv4 address is only 32 bits long. More detailed discussion of the IPv6 standard can be found in Huitema, 1998, IPv6: The New Internet Protocol, Prentice Hall PTR, second edition; Hagen, 2006, IPv6 Essentials, O'Reilly & Associates, second edition; and Blanchet, 2006, Migrating to IPv6: A Practical Guide to Implementing IPv6 in Mobile and Fixed Networks, John Wiley & Sons, each of which is hereby incorporated by reference herein in its entirety.

The present disclosure has broad application in film, video production, animation, and related fields. In such disciplines, a frame is one of the many still images that compose a complete moving picture. Historically, these were recorded on a long strip of photographic film, and each image looked like a framed picture when examined individually, hence the name. When the moving picture is displayed, each frame is flashed on a screen for a short time (e.g., 1/24^{th}, 1/25^{th} or 1/30^{th} of a second) and then immediately replaced by the next frame. Persistence of vision blends the frames together, producing the illusion of a moving image. The video frame is also sometimes used as a unit of time, being variously 1/24, 1/25 or 1/30 of a second, so that a momentary event might be said to last six frames. The frame rate, the rate at which sequential frames are presented, varies according to the video standard in use. In North America and Japan, 30 frames per second is the broadcast standard, with 24 frames per second now common in production for high-definition video. In much of the rest of the world, 25 frames per second is the standard. In film projection, 24 frames per second is the norm, except in some special venue systems, such as IMAX, Showscan and Iwerks wherein 70, where 30, 48 or even 60 frames per second have been used. Silent films and 8 millimeter amateur movies usually are 16 or 18 frames per second.

In ordinary filming, the frames are photographed automatically, one after the other, in a movie camera. In special effects or animation filming, the frames are often shot one at a time. The size of a film frame varies, depending on the film format. In the smallest 8 mm amateur format, it is only about 4.8 by 3.5 mm, while an IMAX frame is as large as 69.6 by 48.5 mm. The larger the frame size is in relation to the size of the projection screen, the sharper the image will appear.

Given the large number of frames found in films, the question arises as to whether there are enough IPv6 addresses to assign unique IP addresses to all of the frames found in such films in the manner set forth in the embodiments of the present disclosure. To address this question, an analysis of the total number of frames that are expected to be produced in the next 100 years by production companies was made. These calculations, run under both the assumption of a 30 frame per second film rate and a 60 frame per second film rate, are summarized in Table 1 below. From the conservative estimates set forth in the table, it can be seen that the estimated total number of frames that are expected to be produced in the next 100 years is less than one one-hundred trillionth of one percent of the total number of the 3.40282×10³⁸ IP addresses available under IPv6. Thus, clearly, there are a sufficient number of IPv6 addresses to support the disclosed systems and methods for securing videos.

TABLE 1
Number of frames estimated to be created in the film industry
in the next century.

| | Frames/Second | |
|---|---|---|
| | 30 | 60 |
| Seconds/Min | 60 | 60 |
| Seconds/Hr | 3,600 | 3,600 |
| Seconds/Day | 86,400 | 86,400 |
| Seconds/year | 31,557,600 | 31,557,600 |
| Frames/Year | 946,728,000 | 1,893,456,000 |

Daily Production Volume

| | | |
|---|---|---|
| North America | 150,000,000 | 150,000,000 |
| South America | 60,000,000 | 60,000,000 |
| Asia | 300,000,000 | 300,000,000 |
| Europe | 80,000,000 | 80,000,000 |
| Africa | 30,000,000 | 30,000,000 |
| Unique Productions/ | 620,000,000 | 620,000,000 |
| Day | | |
| Unique Productions/ | 226,300,000,000 | 226,300,000,000 |
| Year | | |
| Unique Frames/Year | 2.142E+20 | 4.285E+20 |
| Unique Frames/100 | 2.142E+22 | 4.285E+22 |
| Years | | |

(Binary factor) 2

| | | |
|---|---|---|
| IPv6 Addresses | 3.40282E+38 | 3.40282E+38 |
| (TOTAL) | | |
| PERCENT IPv6 | 0.00000000000000630% | 0.0000000000000126% |
| INVENTORY | | |
| REQUIRED | | |

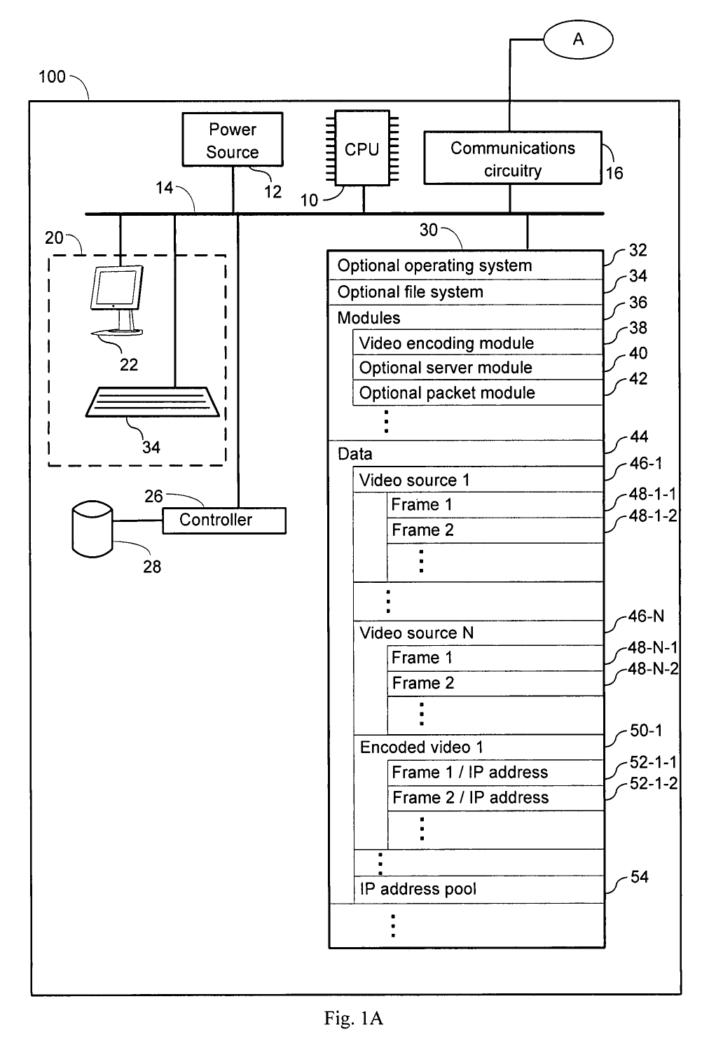

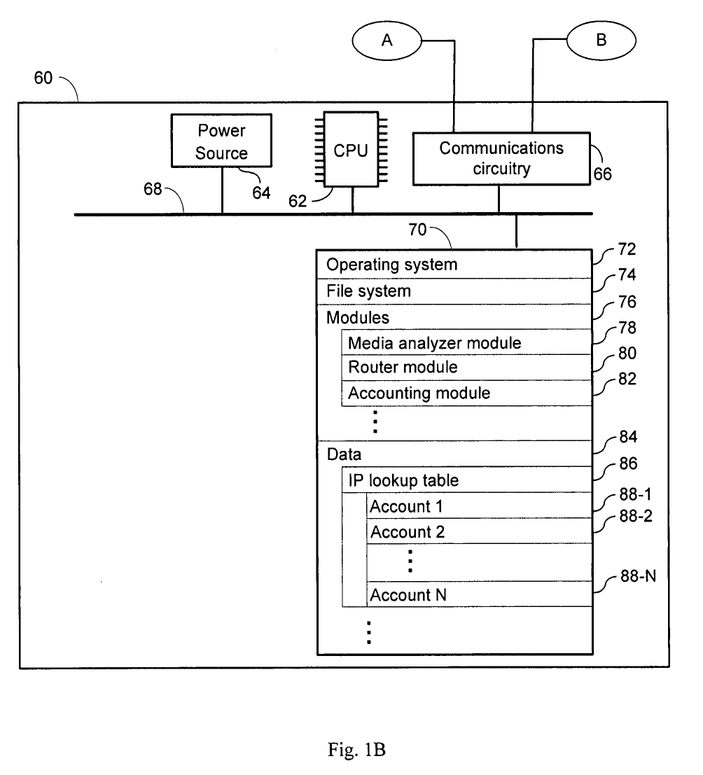

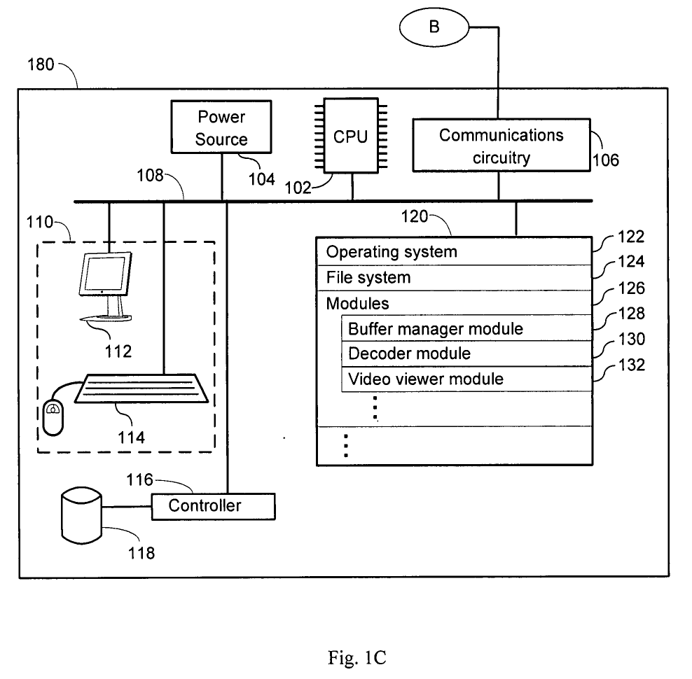

FIG. 1 details an exemplary system that supports the functionality described above. FIG. 1 is divided into three components. FIG. 1A details an exemplary apparatus 100 for encoding videos, FIG. 1B details an exemplary apparatus 60 for communicating encode video, and FIG. 1C details an exemplary apparatus for viewing encoded video.

Referring to FIG. 1A, the exemplary apparatus 100 for encoding videos has:
a central processing unit or other form of microcontroller 10;
an optional main non-volatile storage unit 28, for example, a hard disk drive, for storing software and data, the storage unit 28 controlled by controller 26;
a system memory 30, for storing system control programs, data, and application programs, optionally loaded from optional non-volatile storage unit 28; system memory 30 may also include read-only memory (ROM) or other forms of computer readable media;
a user interface 20, comprising one or more input devices (e.g., keyboard 34) and a display 22 or other output device;
communications circuitry 16 for connecting to another device, optionally through a network connection (e.g., the Internet or any other wide area network), and optionally through a hardwire connection (e.g., a USB, serial, parallel, or FireWire port);
an internal bus 14 or other electronic communication system for interconnecting the aforementioned elements of the system; and
a power source 12 to power the aforementioned elements. Exemplary apparatus 100 can be any device for encoding videos. For example, exemplary apparatus 100 can be a general purpose digital computer, a video camera (e.g., a digital video camera recorder), or other type of device. In the case where apparatus 100 is a general purpose digital computer, operation of apparatus 100 is controlled primarily by operating system 32, which is executed by central processing unit 10. It will be recognized that in embodiments where apparatus 100 is not a general purpose digital computer (e.g., apparatus 100 is a video camera or other type of device), the apparatus may not have an operating system 32. Operating system 32 can be stored in system memory 30. In addition to operating system 32, in a typical implementation where apparatus 100 is a general purpose digital computer, system memory 30 can include a file system 34 for controlling access to the various files and data structures. It will be recognized that in embodiments where apparatus 100 is not a general purpose digital computer (e.g., apparatus 100 is a video camera or other type of device), the apparatus may not have a file system 34. In apparatuses 100 that are not a general purpose digital computer, there may be functionality present in the apparatus that serves the equivalent of operating system 32 and/or file system 34.

Apparatus 100 includes one or more modules 36 for carrying out the disclosed functionality. For instance, apparatus 100 includes a video encoding module 38 comprising instructions for obtaining a video source 46 comprising a plurality of sequential frames 48, and assigning select frames 48 in the plurality of sequential frames with at least one IP address from an IP address pool 54, thereby forming an encoded video 50 containing at least one embedded IP address. Video encoding module 38 further includes instructions for removing the at least one IP address from the IP address pool 54 that is in the encoded video 50 and storing the encoded video.

In some embodiments, memory 30 stores more than one video source 46, with each such video source 46 containing many frames 48. In some embodiments, memory 30 stores only a single video source 46. In some embodiments, memory 30 does not store any video source 30. In such embodiments, the video source 46 is converted to an encoded video 50 prior to storage in memory 30. In some embodiments, video encoding module 38 only stores encoded video 50 in memory transiently before the encoded video is transmitted to an external device. In some embodiments, memory 30 stores 2 or more, 3 or more, 4 or more, 5 or more, 10 or more, 100 or more, or 1000 or more video sources 44. Each such video 46 source typically has more than one frame 48. However, embodiments where a video source has only a single frame 48 are also possible. In typical embodiments, each video source 46 includes 1 or more frames 48, 2 or more frames 48, 10 or more frames 48, 1000 or more frames 48, or 10,000 or more frames 48. Likewise, memory 30 can store one or more encoded videos 50, each containing one or more frames 52 that have been encoded with an IP address. In some embodiments, memory 30 stores 2 or more, 3 or more, 4 or more, 5 or more, 10 or more, 100 or more, or 1000 or more encoded videos 50.

In some embodiments, memory 30 stores a server module 40 that monitors a communication port for requests for an encoded video 50 and transmits a copy of the encoded video 50 through the communication port when a request for the encoded video 50 is received. It will be appreciated that server module 40 and video encoding module 38 may be different components of the same program or process or, indeed, independent programs or processes that are executed by CPU 10. In some embodiments, the communications port is a port such as a USB port, a FireWire port, an Ethernet port, a serial port (RS-232 or RS-422), or a parallel port and forms a part of communications circuitry 16. The port may be connected to another device by a suitable cable. For example, in one embodiment, apparatus 100 is a movie camera that includes a USB or FireWire port. The movie camera is connected to a general purpose computer via the USB or FireWire port and server module 40 transmits a copy of the encoded video 50 through the communication port. In some embodiments, communications circuitry 16 is connected to a wide area network such as the Internet and requests for the encoded video are received over the wide area network. When such requests are received, server module 40 transmits a copy of the encoded video 50 through the communication port for transmission over the wide area network.

In some embodiments video source 46 is in any of a wide variety of formats. In nonlimiting examples, video source 46 is in any of the formats listed in Table 2 below. It will be noted from Table 2 that compressed formats as wells as uncompressed formats may be used in the present application.

TABLE 2
Nonlimiting exemplary file formats for video source 46.

| Extension | File format |
|---|---|
| .3g2, .3gp, .3gp2, .3gpp | 3GPP Multimedia File |
| .3mm | 3D Movie Maker Movie |
| .60d, .ajp | CCTV Video Clip |
| .asf | Advanced Systems Format File |
| .asx | Microsoft ASF Redirector File |
| .avi | Audio Video Interleave File |
| .avs | Application Visualization System Format |
| .bik | BINK Video File |
| .bix, .box | Kodicom Video |
| .byu | Brigham Young University Movie |
| .cvc | cVideo |
| .dce | DriveCam Video |
| .dif | Digital Interface Format |
| .dir | Macromedia Director Movie |
| .divx | DivX-Encoded Movie |
| .dv | Digital Video File |
| .dvr-ms | Microsoft Digital Video Recording |
| .dxr | Protected Macromedia Director Movie |
| .eye | Eyemail Video Recording |
| .fla | Macromedia Flash Animation |
| .flc | FLIC Animation |
| .fli | FLIC Animation |
| .flv | Flash Video |
| .flx | FLIC Animation |
| .gl, .grasp | GRASP Animation |
| .gvi | Google Video File |
| .gvp | Google Video Pointer |
| .ifo | DVD-Video Disc Information |
| .imovieproject | iMovie Project |
| .ivf | Indeo Video Format File |
| .ivs | Internet Streaming Video |
| .izz | Isadora Patch |
| .lsf | Streaming Media Format |
| .lsx | Streaming Media Shortcut |
| .mlv | MPEG-1 Video File |
| .m2v | MPEG-2 Video |
| .m4e | MPEG-4 Video File |
| .m4u | MPEG-4 Playlist |
| .m4v | iTunes Video File |
| .mjp | MJPEG Video File |
| .mkv | Matroska Audio/Video File |
| .moov, .mov | Apple QuickTime Movie |
| .movie | QuickTime Movie |
| .mp4 | MPEG-4 Video File |
| .mpe | MPEG Movie File |
| .mpeg, .mpg | MPEG Video File |
| .mpv2 | MPEG-2 Video Stream |
| .msh | Visual Communicator Project File |
| .mswmm | Windows Movie Maker Project |
| .mvb | Multimedia Viewer Book Source File |
| .mvc | Movie Collector Catalog |
| .nvc | NeroVision Express Project |
| .ogm | Ogg Vorbis Video File |
| .omf | Open Media Framework |
| .prproj | Premiere Pro Project |
| .prx | Windows Media Profile |
| .qt | Apple QuickTime Movie |
| .qtch | QuickTime Cache File |
| .rm | Real Media File |
| .rmvb | RealVideo Variable Bit Rate |
| .rp | RealPix Clip |
| .rts | RealPlayer Streaming Media |
| .rts | QuickTime Real-Time Streaming Format |
| .scm | ScreenCam Recording |
| .smil | Synchronized Multimedia Integration Language |
| .smv | VideoLink Mail Video |
| .spl | FutureSplash Animation |
| .ssm | Standard Streaming Metafile |
| .svi | Samsung Video File |
| .swf | Macromedia Flash Movie |
| .tivo | TiVo Video File |
| .vdo | VDOLive Media File |
| .vfw | Video for Windows |
| .vid | QuickTime Video |
| .viewlet | Qarbon Viewlet |
| .viv | VivoActive Video File |
| .vivo | VivoActive Video File |
| .vob | DVD Video Object |
| .vro | DVD Video Recording Format |
| .wm | Windows Media |
| .wmd | Windows Media Download Package |
| .wmv | Windows Media Video File |
| .wmx | Windows Media Redirector |
| .wvx | Windows Media Video Redirector |

Referring to FIG. 1A, in some embodiments, memory 30 further comprises an optional packet module 42 that packs encoded video 50 into a plurality of packets prior to the transmission of the encoded video by server module 40. The plurality of packets retain the at least one embedded IP address in the encoded video 50.

As illustrated in FIG. 1A, apparatus 100 comprises software program modules (e.g., modules 38, 40 and 42) and data structures (e.g., video sources 46 and encoded videos 50). In some embodiments, each of the aforementioned data structures that are stored in or are accessible to apparatus 100 is a single data structure. In other embodiments, such data structures, in fact, comprise a plurality of data structures that may or may not all be stored in apparatus 100. For example, in some embodiments, video sources 46 and/or encoded videos 50 can be stored either in apparatus 100 (in memory 30 and/or 28) and/or on devices that are addressable by apparatus 100 across a network or the Internet in one or more files.

In one embodiment, apparatus 100 is either an HDTV camera or a device that processes HDTV camera signals. HDTV generates a raw video stream of, for example, more than one billion bits per second. This stream is then compressed in order to fit in the bandwidth of available TV channels and/or to fit on DVDs by video encoding module 38. Such video compression is practical because the data in pictures is often redundant in space and time. For example, the sky can be blue across the top of a picture and that blue sky can persist for frame after frame. Also, because of the way the eye works, it is possible to delete some data from video pictures with almost no noticeable degradation in image quality. In some embodiments, apparatus 100 is a TV camera or a device that processes the TV camera signal. TV cameras used in broadcasting usually generate 50 pictures a second (in Europe and elsewhere) or 59.94 pictures a second (in North America and elsewhere). Digital television requires that these pictures be digitized so that they can be processed by computer hardware. Each picture element (a pixel) is then represented by one luminance number and two chrominance numbers. These describe the brightness and the color of the pixel. Thus, each digitized picture is initially represented by three rectangular arrays of numbers. One method that can be used to reduce the amount of data that must be processed per second by video encoding module 38 is to separate the picture into two fields: the “top field,” which is the odd numbered rows, and the “bottom field,” which is the even numbered rows. The two fields are displayed alternately. This is called interlaced video. Two successive fields are called a frame. The typical frame rate is then 25 or 29.97 frames a second. If the video is not interlaced, then it is called progressive video and each picture is a frame. Another method to reduce the data rate is to thin out the two chrominance matrices. In effect, the remaining chrominance values represent the nearby values that are deleted. Thinning works because the eye is more responsive to brightness than to color. The 4:2:2 chrominance format indicates that half the chrominance values have been deleted. The 4:2:0 chrominance format indicates that three quarters of the chrominance values have been deleted. If no chrominance values have been deleted, the chrominance format is 4:4:4.

Referring to FIG. 1B, there is shown an exemplary apparatus 60 for communicating an encoded video 50. Apparatus 60 comprises
a central processing unit or other form of microcontroller 62;
a system memory 70, for storing system control programs, data, and application programs, system memory 70 may also include read-only memory (ROM) or other forms of computer readable media;
communications circuitry 66 that is in electronic communication with a source computer and in electronic communication with at least one destination computer;
an internal bus 68 or other electronic communication system for interconnecting the aforementioned elements of the system; and
a power source 64 to power the aforementioned elements.

In some embodiments, communications circuitry 66 comprises a switch fabric having a plurality of input ports and a plurality of output ports. Switch fabrics are described in Peterson & David, Computer Networks, Morgan Kaufman Publishers, Inc., San Francisco, Calif., 1996, pp. 188-204, which is hereby incorporated by reference herein in its entirety. Memory 70 optionally includes an operating system 72 and a file system 74. Memory 70 includes data 84 for operation, including lookup table 86. Lookup table 86 contains a plurality of accounts 88. Each account is associated with a different entity. In some instances, an advertiser may hold an account 88. In some instances, a recipient of an encoded video may hold an account 88. In some instances, apparatus 60 will not forward an encoded video to an end user unless they have an account 88. In some embodiments, an account 88 is created automatically for an end user in lookup table 86 when an encoded video is sent to the end user. In some embodiments, apparatus 60 is owned, leased to, operated by, or otherwise controlled by an Internet service provider (ISP) and accounts 88 include the accounts of the ISP customers. In some embodiments apparatus 60 is a router or is in electronic communication with a router.

Apparatus 60 receives packets through communications circuitry 66 and routes them to their proper destination based on destination addresses contained within the packets. Such action is facilitated by router module 80, which is one of the modules 76 that is either stored in or accessible to memory 70. Router module 80 includes instructions for reading an address of each of a plurality of packets received by communications circuitry 66. In some instances, the plurality of packets collectively store an encoded video 50 containing at least one embedded IP address. Further, each of the packets in the plurality of packets contains a destination address. Router module 80 further includes instructions for routing the plurality of packets to a destination computer based on the destination address contained within the packets.

Memory 70 further includes or has instructions for accessing a media analyzer module 78. Media analyzer module 78 includes instructions for identifying values of the at least one embedded IP address in the plurality of packets that collectively store an encoded video 50. Media analyzer module 78 passes such values to accounting module 82 which, in turn, charges an account 88 in lookup table 86 for the encoded video 50. In one example, the account 88 to be charged is that of an advertiser, the encoded video 50 is an advertisement, and the account 88 is identified by a value of at least one embedded IP address in the plurality of packets that collectively store the encoded video. In another example, the account 88 to be charged is the account of a user of the destination computer (e.g., computer 180) and accounting module 82 further comprises instructions for crediting an account 88 of an owner of the encoded video 50. In such embodiments, the account 88 of the owner of the encoded video 50 is in the lookup table 86 and the account 88 of the owner of the encoded video 50 is identified by a value of at least one embedded IP address in the encoded video.

Apparatus 60 can route a plurality of packets to any of several destinations. FIG. 1C illustrates one such destination, computer 180. Computer 180 is typically operated by a user that has requested to see an encoded video 50. In preferred embodiments, the user of computer 180 is not aware that the video is encoded with IP addresses. In typical embodiments, computer 180 includes:
a central processing unit or other form of microcontroller 102;
an optional main non-volatile storage unit 118, for example, a hard disk drive, for storing software and data, the storage unit 118 controlled by controller 116;
a system memory 120, for storing system control programs, data, and application programs, optionally loaded from optional non-volatile storage unit 118; system memory 120 may also include read-only memory (ROM) or other forms of computer readable media;
a user interface 110, comprising one or more input devices (e.g., keyboard 114, mouse) and a display 112 or other output device;
communications circuitry 106 for connecting to another device optionally through a network connection (e.g., the Internet or any other wide area network) and optionally through a hardwire connection (e.g., a USB, parallel, serial, or FireWire port);
an internal bus 108 or other electronic communication system for interconnecting the aforementioned elements of the computer 180; and
a power source 104 to power the aforementioned elements.

Operation of computer 180 is controlled primarily by operating system 122, which is executed by central processing unit 102. Operating system 122 can be stored in system memory 120. In addition to operating system 122, in typical implementations, system memory 120 includes a file system 124 for controlling access to the various files and data structures. Computer 180 is capable of viewing encoded videos and, therefore, includes standard modules 126 such as a buffer manager module 128 for receiving a plurality of packets that collectively encode the encoded video 50, a decoder module 130 for decoding the plurality of packets, and a video viewer 132 for viewing the video.

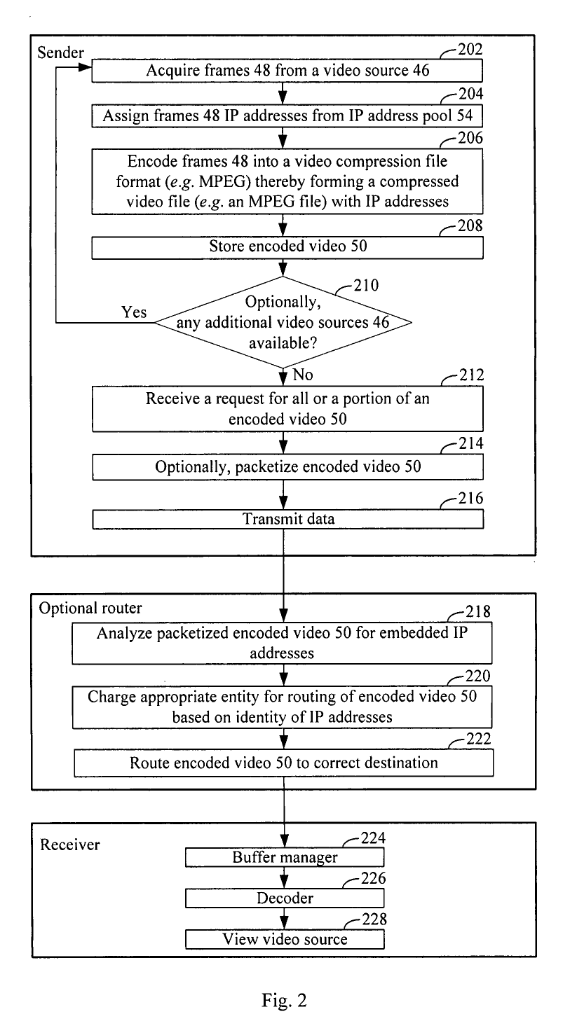

An overview of systems in accordance with the present invention has been presented. FIG. 2 illustrates exemplary processing steps in accordance with the present invention. The steps illustrated in FIG. 2 are divided into three classifications, sender (steps 202-216), optional router (steps 218-222), and receiver (steps 224-228). In typical embodiments, the sender steps are performed using a device such as apparatus 100 of FIG. 1A, the optional router steps are performed by an apparatus such as apparatus 60 of FIG. 1B, and the receiver steps are performed by a client-side computer such as computer 180. However, other embodiments are possible. For example, sender steps and the optional router accounting activity could all be performed on the same device.

Step 202. In step 202, frames 48 from a video source 46 are acquired. In some embodiments, the frames 48 are acquired from a remote device. In some embodiments, frames 48 are generated by the same device that processes steps 202-216 such as, for example, a digital video camera recorder.

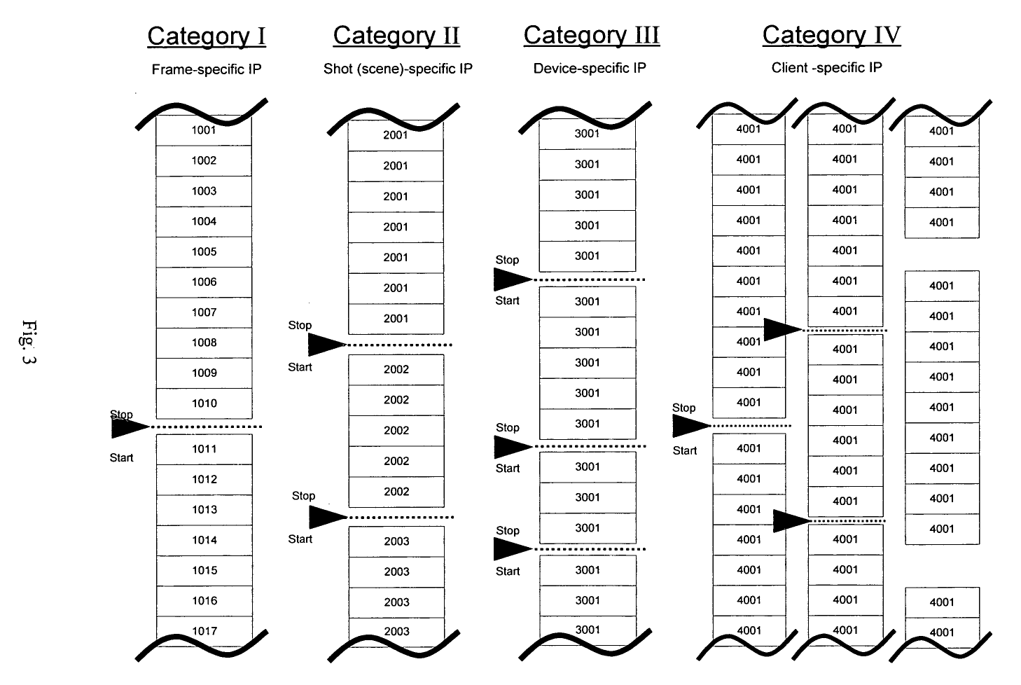

Step 204. In step 204, select frames 48 in the video source 46 are watermarked or otherwise permanently encoded with an IP address. There are several different categories of encoding that may occur in step 204. FIG. 3 provides a nonexclusive list of some of these categories. The categories illustrated in FIG. 3 are defined by the degree of precision to which a content creator will allocate unique IP addresses to the media being created. The categories illustrated in FIG. 3 all share the common characteristics of linear (time-segmented) content and the use of a device that can assign authorized IP addresses at the point of origination. In this manner, every subsequent manifestation of the original media, from the post production process through many layers of distribution and duplication, will include its original IP “fingerprint” permanently attached to its audio/video file.

Category One. Category one assigns a unique IP address to each frame 48. In some embodiments, this assignment is performed as each frame 48 is recorded at the moment of origination. In some embodiments, the IP embedding device, such as device 100, is designed to activate when recording (frame storage) is occurring. The device then allocates a sequence of differentiated IP addresses in a continuous fashion from IP address pool 54 to each frame 48 being recorded. In common practice, the device will also identify any random start and stop points during the recording process and manage the inventory of IP address pool 54 for optimal efficiency. In some embodiments, it is expected but not mandatory that each sequential frame 48 of linear media is assigned a subsequent IP address. In this manner, individual “shots”, sequences of frames 48 between any “start” and “stop” command, would have serialized IP addresses, similar to NTSC time-code or the edge-numbers in sprocket motion-picture film. Because of its “high-density” digital rights management (DRM) capability, category one will be most commonly used by creators of high-end content where every frame 48 of content has a measurable value, especially when one considers the potential of the emerging distribution networks.

Category Two. Category two describes any means by which one IP address is assigned to every frame 48 being recorded during the continuous recording of a single “shot”—in other words, between the “start” and “stop” command of the recording mechanism. In this mode, one single IP address is unique to the sequence being recorded, and can be traced back to the moment of creation but not at the frame level. Each subsequent “start” command will initialize a new IP address that will be permanently attached to the media until the “Stop” command is received. And so on. Category two presents a more efficient usage of IP address inventory from IP address pool 54 with respect to category one, yet still provides a high degree of digital rights management accountability at a scene or shot-by-shot level. Category two is particularly advantageous for content providers with high-to-medium rights management responsibilities such as video news organizations, corporate production clients, lower-budget program producers, high-end (pro-sumer) electronics manufacturers and other clients where DRM granularity is sufficient at the “scene” level.

Category Three. Category three describes any means by which a single IP address is permanently assigned to a single media recording device such as a video camera or digital SLR so that every frame of media produced by this device will contain the same unique IP address. In this manner, the content can be permanently associated with that device (e.g., device 100 in some embodiments) and, by inference, back to the content creator. As with the other categories, the IP address can be coupled with an affidavit of ownership establishing the subsequent rights of all media created using that device (until such time as the device legally changes hands). Because of its limitations as a DRM standard, category three is most advantageous in consumer electronics and as well as less ambitious news-gathering and corporate video operations. However, as a consumer standard, what category three lacks in DRM, it makes up for due to its basic security and crime-prevention potential.

Category Four. Category four assigns a single IP address, or a small “clutch” of addresses, to a single client for use across one or several devices (e.g., for several devices 100) and/or across one or several productions. This category is particularly advantageous for archival libraries or low-distribution content where the rights owner wants to provide a layer of DRM protection across a wide portfolio of content. Because of its modest inventory requirements, category four is particularly advantageous in applications such as service based businesses (e.g., as Kinkos, or local photo labs) that intermediate between consumers and the IP address inventory and registration bodies.

Step 206. The product of step 204 is an encoded video 50 that includes frames 52, one or more of which has been permanently assigned an IP address. Step 206 is optional. However, step 206 is advantageous in embodiments where the encoded video 50 is to be transmitted to an external device. Step 206 is also advantageous in embodiments where encoded video 50 is to be stored in computer readable media (e.g., digital media). For example, step 206 is advantageous in embodiments where apparatus 100 is a digital video camera recorder that stores encoded videos 50. In step 206, the frames 52 of encoded video 50 are further encoded into a video compression file format (e.g., MPEG) thereby forming a compressed video file (e.g., an MPEG file). This compressed video file is also referred to as an encoded video 50 because it retains the IP assignments described in step 204. In other words, the IP addresses assigned in step 204 are not lost during compression step 206. In some preferred embodiments, steps 204 and 206 are concurrently performed.

In an exemplary embodiment, step 206 compresses encoded video 50 into an MPEG-4 file. MPEG-4 is a standard used primarily to compress audio and visual (AV) digital data. MPEG-4 is the designation for a group of audio and video coding standards and related technology set forth by the ISO/IEC Moving Picture Experts Group (MPEG) under the ISO/IEC 14496 standard. With MPEG-4, encoded video 50 can be distributed by streaming media, distributed on CD or DVD, or broadcast on television. MPEG-4 encompasses many of the features of MPEG-1 and MPEG-2 and related standards, adding new features such as extended VRML support for 3D rendering, object-oriented composite files (including audio, video and VRML objects), support for externally-specified digital rights management and various types of interactivity.

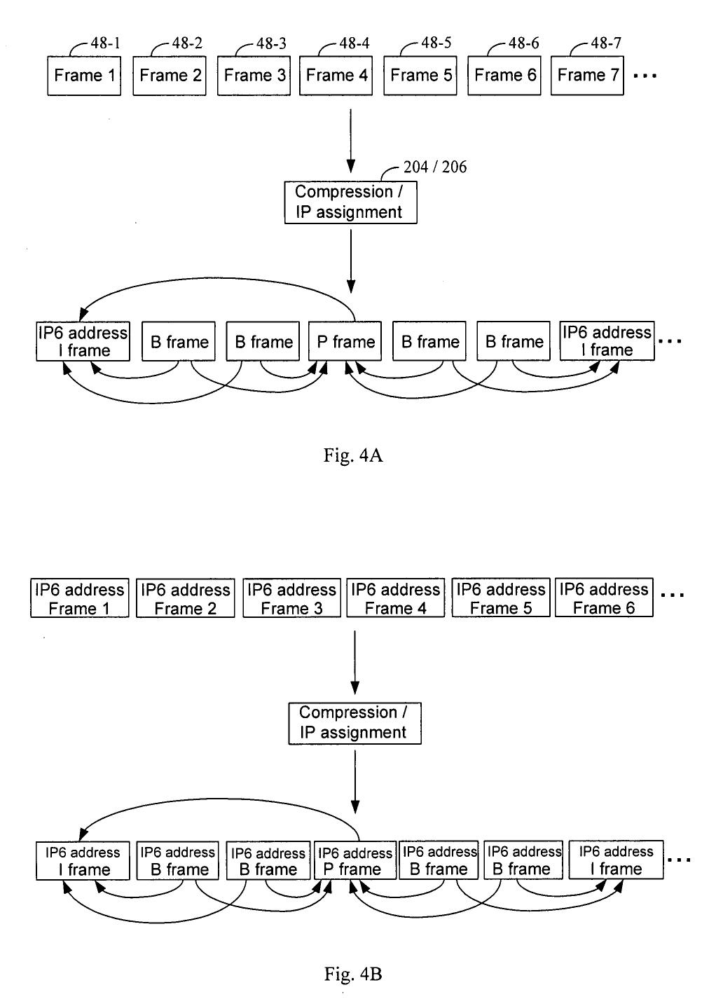

In some embodiments, steps 204 and 206 are concurrently performed and IP addresses are only assigned to the key frames in the compressed video file. To appreciate this embodiment consider the observation that, to a first approximation, a moving picture (i.e., a video) is a succession of still images (frames) displayed at some video rate. Each of these frames can be compressed using, for example, a DCT-based technique used in JPEG. Stopping at this point is unsatisfactory, however, because of the frame-to-frame redundancy present in the video sequence. For example, two successive frames of video will contain almost identical information if there is not much motion in the scene, and it would be unnecessary to send the same information twice. Even when there is motion, there may be redundancy since a moving object may not change from one frame to the next; in some cases, only its position changes. Video compression techniques, such as MPEG, take this interframe redundancy into consideration. For instance, referring to FIG. 4A, MPEG and several other video compression techniques takes a sequence of video frames 48 as input and compresses them into three types of frames, called I frames (intrapicture, also known as key frames), P frames (predicted picture), and B frames (bidirectional predicted picture). In some embodiments, each frame of input is compressed into one of these three frame types. I frames are reference frames; they are self-contained, depending on neither earlier frames or nor later frames. To a first approximation, an I frame is the JPEG (or equivalent) compressed version of the corresponding frame 48 in video source 46. P and B frames are not self-contained; they specify relative differences from some reference frame. More specifically, a P frame specifies the difference from the previous I frame, while a B frame gives an interpolation between the previous and subsequent I or P frames.

FIG. 4A illustrates a sequence of video frames 48 that, after being compressed and assigned IP values in accordance with steps 204 and 206 of FIG. 2, result in a sequence of I, P, and B frames. The I frames stand alone; each can be decompressed at the receiver independently of any other frames. Each P frame depends on the preceding I frame; it can be decompressed at the receiver only if the preceding I frame also arrives. Each B frame depends on both the preceding I or P frame and the subsequent I or P frame. Both of these reference frames must arrive at the receiver before the B frame can be decompressed to reproduce the original video frame. For more information on such encoding schemes, see Peterson & David, Computer Networks, Morgan Kaufman Publishers, Inc., San Francisco, Calif., 1996, pp. 364-368, which is hereby incorporated by reference herein in its entirety.

In the embodiment illustrated in FIG. 4A, only the I frames are assigned IP addresses. In some embodiments, each I frame produced from a given video source 46 is assigned a different IP address. In some embodiments, each I frame produced from a given video source 46 is assigned the same IP address. In fact, the encoding scheme of FIG. 4A supports any of the categories that has been outlined in FIG. 3 and described above in conjunction with step 204, with the limitation that only the I frames are eligible for IP addresses. FIG. 4B is similar to the encoding scheme of FIG. 4A with the exception that B frames and the P frames can also be assigned IP addresses.

Step 208. In step 208, the encoded video 50 of step 204 and optional step 206 is stored. In some embodiments, the encoded video 50 is stored in electronic memory (e.g., memory 30 of device 100 illustrated in FIG. 1A). In some embodiments, encoded video 50 is stored in a CD, a DVD, digital tape, or some other form of computer readable media.

Step 210. In step 210 a determination is made as to whether there are any additional video sources 46 available. Step 210 is optional and is used in instances where the sender steps 202-216 are performed, for example, by a server that provides a library of encoded videos 50 that are available for downloading across a wide area network connection such as the Internet. If an additional video source 46 is available that has not been encoded (210-Yes), steps 202 through 208 are repeated for the additional video source 46. In some embodiments, video sources 46 are encoded by step 204 and optional step 206 at the time the video source is created. In such embodiments, a decision block 210 is unnecessary. In such embodiments, and in embodiments where decision block 210 is used but there are no additional video sources 46 available that have not already been compressed (210-No), process control passes to step 212.

Step 212. In step 212, a request for all or a portion of an encoded video is received. In typical embodiments, this request is received from a device that is remote to the device that executes sender steps 202 through 216. For example, in one embodiment, this request is received from a remote device over a wide area network connection (e.g., the Internet). In such an embodiment, the device running steps 202 through 216 acts as a server distributing encoded videos 50. In another embodiment, the request is received from a remote device that has been hardwired to the device executing steps 202 through 216. For instance, the remote device may be hardwired through a USB port, a FireWire port, or some other type of port. In such an embodiment the device running steps 202 through 216 may in fact be a device that created the video source (e.g., a digital video camera recorder). The request received in step 212 will typically designate which encoded video 50 is desired, in situations where there is more than one encoded video 50 available and, optionally, which portion of the encoded video 50 is desired. In some embodiments, a request does not indicate which portion of the encoded video 50 is desired and it is assumed that the entire encoded video is desired.

Step 214. In step 214, the encoded video 50 for which a request was received in step 212 is packetized. Such packetizing is particularly useful in situations where the encoded video 50 is to be transmitted over a wide area connection such as the Internet. Such packets include a header and a payload. The header includes, among other information, the destination address. In some embodiments, the header includes an indication that the packets include an encoded video 50. There are many packetizing schemes available in the art, and all such schemes can be used in accordance with the present application. In some embodiments, such packets are fixed length cells such as 53 byte cells suitable for transmission through an ATM network (e.g., user-network interface or network-network interfaces cells). In some embodiments, the packets are IPv4 or IPv6 packets. IPv6 packets are described in Peterson & David, Computer Networks, Morgan Kaufman Publishers, Inc., San Francisco, Calif., 1996, pp. 252-262, which is hereby incorporated by reference herein in its entirety. The product of optional step 214 is a plurality of packets that collectively store an encoded video 50 and that retain the IP addresses assigned to one or more frames in the encoded video 50.

Step 216. In step 216, the requested encoded video 50 is transmitted to an external device. As noted above, this external device may be hardwired to the device that executed sender steps 202-216 (e.g., a FireWire connection or USB connection, etc.) or the external device may be connected to the device that executed sender steps 202-216 by a wide area connection such as the Internet.

Steps 218-222. Steps 218 through 222 present one method by which the digital rights of encoded videos 50 may be preserved without the drawbacks of conventional digital rights management (DRM). Further, it will be appreciated that while the disclosed systems and methods can serve as a replacement for conventional DRM, they can also be used in conjunction with conventional DRM. In steps 218-222, a device, such as device 60 of FIG. I B, acts a router. The device received packets from a source, and forwards them to a destination based on a destination address in each of the received packets. In addition to this conventional routing activity, steps 218 through 222 are performed. In step 218, the received packets are analyzed for embedded IP addresses. If such IP addresses are found, in step 220, the appropriate entity is charged for routing the encoded video 50. In step 222, the encoded video 50 is routed to the correct destination. Steps 218 through 222 are highly advantageous because DRM is enforced without the requirement of public key/private key or similarly cumbersome schemes.

Steps 218 through 222 allow for substantial flexibility in the development of ways to charge for the transmission of encoded videos 50. For example, consider the case of an advertiser that wishes to widely distribute an advertisement in the form of an encoded video 50. The encoded video contains IP addresses that identify a debit account held by the advertiser. Each time optional router module 80 routes the encoded video 50 to an end-user, the advertiser's account is identified by a value of at least one embedded IP address in the encoded video 50 and is charged accordingly. In some embodiments, the advertiser's account is charged when the encoded video is transmitted. In some embodiments, the advertiser's account is charged only when confirmation is received that an end user actually viewed all or a portion of the encoded video 50.

In another example in accordance with steps 218 through 220, consider the case where an end-user requests an encoded video 50. The account of a user of the destination computer is charged for the encoded video 50. Furthermore, an account of an owner of the encoded video 50 is automatically credited for the end-user's request. In some instances, the account of the owner of the encoded video is found by analyzing the values of at least one embedded IP address in the encoded video 50.

Steps 224-228. Steps 224 through 228 illustrate typical and conventional activities that are performed on an end-user (client) computer in order to view a media file. For example, steps 224 through 228 could be performed by computer 180 of FIG. 1C. Steps 224-228 highlight the advantages of the present application: the steps performed by the end-user require no public key/private key system, or other form of inconvenient licenses and or keys. If an entity needed to be charged for the requested content, such a charge (and corresponding credit) is automatically handled by a router (e.g., device 60) or a server (e.g., computer 100), or an equivalent device. In step 224, a buffer manager receives a plurality of packets that collectively store the encoded video 50. In embodiments, where a router or other network device performs accounting, the IP addresses in the encoded video could be ignored but are not stripped from the video. Buffer manager step 224 orders the packets in the correct order. Next, decoder step 226 decodes the encoded video. For example, when the packets collectively store an MPEG file, the MPEG file is decoded using conventional MPEG decoding during step 226. In step 228, the video source is viewed. Note, that if the end-user chooses to send the encoded video to others, the router or related network device will once again analyze the encode video and charge the appropriate entity for transmission of the encoded video.

The present invention can be implemented as a computer program product that comprises a computer program mechanism embedded in a computer readable storage medium. Further, any of the methods of the present invention can be implemented in one or more computers or computer systems. Further still, any of the methods of the present invention can be implemented in one or more computer program products. Some embodiments of the present invention provide a computer system or a computer program product that encodes or has instructions for performing any or all of the methods disclosed herein. Such methods/instructions can be stored on a CD-ROM, DVD, magnetic disk storage product, or any other computer readable data or program storage product. Such methods can also be embedded in permanent storage, such as ROM, one or more programmable chips, or one or more application specific integrated circuits (ASICs). Such permanent storage can be localized in a server, 802.11 access point, 802.11 wireless bridge/station, repeater, router, mobile phone, or other electronic devices. Such methods encoded in the computer program product can also be distributed electronically, via the Internet or otherwise, by transmission of a computer data signal (in which the software modules are embedded) either digitally or on a carrier wave.

Some embodiments of the present invention provide a computer program product that contains any or all of the program modules shown in FIGS. 1A, 1B, and/or 1C. These program modules can be stored on a CD-ROM, DVD, magnetic disk storage product, or any other computer readable data or program storage product. The program modules can also be embedded in permanent storage, such as ROM, one or more programmable chips, or one or more application specific integrated circuits (ASICs). Such permanent storage can be localized in a server, 802.11 access point, 802.11 wireless bridge/station, repeater, router, mobile phone, or other electronic devices. The software modules in the computer program product can also be distributed electronically, via the Internet or otherwise, by transmission of a computer data signal (in which the software modules are embedded) either digitally or on a carrier wave. It will be appreciated that the application modules disclosed in FIG. 1 are further the purpose of describing aspects of the present disclosure. In fact, the modules disclosed in FIG. 1 can be merged into one or more modules and distributed for execution on one or more devices that are in electronic communication with each other.

What is claimed:

1. An apparatus for communicating a video, the apparatus comprising:
a central processing unit;
a communications circuit in electronic communication with a source computer and in electronic communication with at least one destination computer; and
a memory, coupled to the central processing unit, the memory comprising:
(A) instructions for accessing a lookup table, the lookup table containing a plurality of accounts;
(B) a router module comprising instructions for controlling said communications circuit, said instructions for controlling said communications circuit comprising:
instructions for reading an address of each of a plurality of packets received by said communications circuit, wherein said plurality of packets collectively store an encoded video containing at least one embedded IP address and wherein said plurality of packets each contain a destination address; and
instructions for routing said plurality of packets to a destination computer in said at least one destination computer based on said destination address; and
(C) a media analyzer module comprising instructions for identifying a value of the at least one embedded IP address in the plurality of packets; and
(D) an accounting module for charging an account in said plurality of accounts for the encoded video.

2. The apparatus of claim 1, wherein the encoded video comprises a plurality of frames and each frame in the plurality of frames is embedded with a different IP address.

3. The apparatus of claim 1, wherein the encoded video comprises a single shot and each frame in the single shot is embedded with the same IP address.

4. The apparatus of claim 1, wherein the encoded video comprises a plurality of shots and the frames of each respective shot in the plurality of shots is assigned an IP address that is unique to the respective shot.

5. The apparatus of claim 1, wherein the encoded video is in a video compression file format that includes one or more key frames, and wherein each of the one or more key frames in said encoded video is embedded with a different IP address.

6. The apparatus of claim 1, wherein the encoded video is in a video compression file format that includes one or more key frames, and wherein each of the one or more key frames in said encoded video is embedded with the same IP address.

7. The apparatus of claim 1, wherein the encoded video is in an MP3 file format that includes one or more I frames, one or more P frames, and one or more B frames, and wherein each of the one or more I frames is embedded with a different IP address.

8. The apparatus of claim 1, wherein each of the one or more B frames and each of the one or more P frames is embedded with a different IP address.

9. The apparatus of claim 1, wherein the at least one embedded IP address is an IPv6 address.

10. The apparatus of claim 1, wherein the communications circuit comprises a switch fabric comprising a plurality of input ports and a plurality of output ports.

11. The apparatus of claim 1, wherein
the account is the account of an advertiser;
said encoded video is an advertisement; and
the account in the plurality of accounts is identified by a value of at least one embedded IP address in the encoded video.

12. The apparatus of claim 1, wherein the account is the account of a user of the destination computer and wherein the accounting module further comprises instructions for crediting an account of an owner of the encoded video, wherein the account of the owner of the encoded video is in said plurality of accounts and where the account of the owner of the encoded video is identified by a value of at least one embedded IP address in the encoded video.

13. A method for communicating a video comprising:
reading an address of each of a plurality of received packets, wherein the plurality of received packets collectively store an encoded video containing at least one embedded IP address and wherein said plurality of packets each contain a destination address;
routing said plurality of packets to a destination corresponding to said destination address in said plurality of packets;
identifying a value of the at least one embedded IP address in the plurality of packets; and
charging an account in a plurality of accounts for the encoded video.

14. The method of claim 13, wherein the encoded video comprises a plurality of frames and each frame in the plurality of frames is embedded with a different IP address.

15. The method of claim 13, wherein the encoded video comprises a single shot and each frame in the single shot is embedded with the same IP address.

16. The method of claim 13, wherein the encoded video comprises a plurality of shots and the frames of each respective shot in the plurality of shots is assigned an IP address that is unique to the respective shot.

17. The method of claim 13, wherein the encoded video is in a video compression file format that includes one or more key frames, and wherein each of the one or more key frames in said encoded video is embedded with a different IP address.

18. The method of claim 13, wherein the encoded video is in a video compression file format that includes one or more key frames, and wherein each of the one or more key frames in said encoded video is embedded with the same IP address.

19. The method of claim 13, wherein the encoded video is in an MP3 file format that includes one or more I frames, one or more P frames, and one or more B frames, and wherein each of the one or more I frames is embedded with a different IP address.

20. The method of claim 19, wherein each of the one or more B frames and each of the one or more P frames is embedded with a different IP address.

21. The method of claim 13, wherein the at least one embedded IP address is an IPv6 address.

22. The method of claim 13, wherein
the account charged is the account of an advertiser;
said encoded video is an advertisement; and
the account in the plurality of accounts is identified by a value of at least one embedded IP address in the encoded video.

23. The method of claim 13, wherein the account is the account of a user associated with said destination address, the method further comprising the step of:
crediting an account of an owner of the encoded video, wherein the account of the owner of the encoded video has an account in said plurality of accounts and wherein the account of the owner of the encoded video is identified by a value of at least one embedded IP address in the encoded video.

24. An apparatus for communicating a video, the apparatus comprising:
a central processing unit;
a memory, coupled to the central processing unit, the memory comprising instructions for:
receiving a request for an encoded video from a destination, wherein said encoded video contains at least one embedded IP address;
communicating said encoded video to said destination address; and
charging an account in a plurality of accounts for the encoded video.

25. The apparatus of claim 24, wherein the at least one embedded IP address is an IPv6 address.

26. The apparatus of claim 24, wherein
the account charged is the account of an advertiser;
said encoded video is an advertisement; and
the account in the plurality of accounts is identified by a value of at least one embedded IP address in the encoded video.

27. The apparatus of claim 24, wherein the account is the account of a user associated with said destination address, the method further comprising the step of:
crediting an account of an owner of the encoded video, wherein the account of the owner of the encoded video has an account in said plurality of accounts and wherein the account of the owner of the encoded video is identified by a value of at least one embedded IP address in the encoded video.
